(19) United States
(12) Patent Application Publication
(10) Pub. No.: US 2020/0058041 A1
(43) Pub. Date: Feb. 20, 2020

(54) System and Method for Generating Predictive Insights Using Self-Adaptive Learning

(71) Applicant: Senso.ai Inc., Toronto (CA)

(72) Inventors: Saroop BHARWANI, Toronto (CA); Nick SEELERT, Toronto (CA)

(21) Appl. No.: 16/664,433

(22) Filed: Oct. 25, 2019

Related U.S. Application Data
(63) Continuation of application No. PCT/CA2018/050494, filed on Apr. 27, 2018.
(60) Provisional application No. 62/491,091, filed on Apr. 27, 2017.

(51) Int. Cl. G06Q 30/02; G06N 20/00; G06F 17/18

(52) U.S. Cl. CPC G06Q 30/0202; G06F 17/18; G06N 20/00; G06Q 30/0201

(57) ABSTRACT

A method and system are provided for generating insights related to customer acquisition and/or retention for a provider of a product or service. The method includes obtaining historical and current data associated with customers; generating at least one predictive insight associated with customer acquisition and/or customer retention using the data and at least one model; for each interaction associated with contact with customers via a channel, collecting and storing outcome data comprising statistical attributes and data; and self-adapting the at least one model using the stored statistical attributes and data to learn new recommendation strategies for customer acquisition and/or customer retention activities.

### CROSS-REFERENCE TO RELATED APPLICATION(S)

This application is a continuation of PCT Application No. PCT/CA2018/050494 filed on Apr. 27, 2018, which claims the benefit of priority to U.S. Provisional Patent Application No. 62/491,091 filed on Apr. 27, 2017, both incorporated herein by reference in their entirety.

### TECHNICAL FIELD

The following relates to systems and methods for generating predictive insights using self-adaptive learning, for example to determine the discharge propensity, risk profile, present or future customer value, optimal price and/or product offering, and/or optimal treatment method to enable optimal acquisition and retention activities for providers of products and/or services. The system can be further adapted for generating recommendations related to consumer offerings and/or contact channels for contacting such consumers.

### BACKGROUND

Businesses are known to set aside large budgets to acquire new customers and are typically negatively impacted when the same customers discharge as a result of acquiring similar products from other providers. This type of behavior commonly occurs with mortgage loans because of life stage or lifestyle changes, property listings and purchases, interest rate fluctuations, or other influences, including for example, brokers, loan officers, realtors, the news, and social media.

Methods currently used to acquire or retain customers are known to be linear and non-adaptive, which decay extremely quickly, and lack the ability to detect and react to changes in volatile economic and market landscapes, where customer behavior is constantly changing. More specifically, current methods of determining which customers to contact (or re-contact) are found to be linear, reactive, and inefficient often resulting in the prioritization of those who are already set on buying the product, regardless of whether they are contacted or not. Being able to predict, segment, and prioritize persuadable customers, while avoiding ones with a high propensity to buy products without being contacted, in real-time, is found to be lacking, and would be extremely beneficial to service and/or product providers, such as lenders, looking to implement strategies to acquire new customers, and retain existing ones. That is, current methods fail to segment based on factors such as customer persona, resulting in the prioritization of customers who are already set on buying, versus persuadable customers, and fail to avoid customers who are a lost cause.

Accordingly, there is a need to develop a method and system for addressing these inefficiencies by enabling providers of products and/or services (e.g., businesses) the ability to manage their customer acquisition and retention efforts.

It is an object of the following to address at least one of the above-noted challenges or disadvantages.

### SUMMARY

It is recognized that self-adaptive methods, when exposed to new data, understand the current environmental context and adjust its predictions based on that understanding. This allows the system to continuously evolve based on differences and changes in customer personas, and can be used to address customer acquisition and retention management efforts on behalf of a provider of a product and/or service.

The proposed system can be used to automatically segment and personify a group of customers based on predicted discharge propensity, risk profile, present or future value, optimal price and/or product offering, and/or optimal contact channel method to treat the customer. In addition to solving the a priori problem, customers themselves can be provided with a more transparent and guided process and experience.

In one aspect, there is provided a method of generating insights related to customer acquisition and/or retention for a provider of a product or service, the method comprising: obtaining historical and current data associated with customers; generating at least one predictive insight associated with customer acquisition and/or customer retention using the data and at least one model; for each interaction associated with contact with customers via a channel, collecting and storing outcome data comprising statistical attributes and data; and self-adapting the at least one model using the stored statistical attributes and data to learn new recommendation strategies for customer acquisition and/or customer retention activities.

In other aspects, there are provided computer readable media and systems for performing the method.

### BRIEF DESCRIPTION OF THE DRAWINGS

Embodiments will now be described with reference to the appended drawings wherein:

FIG. 1 is a schematic diagram of an example of a computing environment in which a predictive insight system is provided to, or used by, one or more product or service providers to generate predictive insights for that provider;

FIG. 2 is an illustrative view of example predictions and factors considered by the predictive insight system;

FIG. 3 is a schematic diagram illustrating additional detail for the predictive insight system and components of the product or service provider interfaced with the system;

FIG. 4 is a flow chart illustrating operations performed by a self-adaptive training module;

FIG. 5 is a flow chart illustrating further detail associated with the operations performed by the self-adaptive training module;

FIG. 6 is a screen shot of a graphical user interface providing a portfolio screen showing a high-level overview of a provider's portfolio;

FIG. 7 is a screen shot of a graphical user interface providing recommended acquisition strategies;

FIG. 8 is a screen shot of a graphical user interface provided recommended retention strategies;

FIG. 9 is a screen shot of a graphical user interface providing a prioritized customer list based on predictions performed by the system;

FIG. 10 is an enlarged view of a portion of the interface shown in FIG. 9 with an action showing risk details and further information; and

FIG. 11 is a screen shot of a graphical user interface showing a map view with data and predictive insights aggregated by geography.

### DETAILED DESCRIPTION

The present disclosure relates to a system and method for generating predictive insights, using self-adaptive learning. The self-adaptive learning capabilities are used to automatically generate the predictive insights. Non-limiting examples of predictive insights that can be generated include: i) recommended strategies to acquire new customers, and ii) recommended strategies to preempt threats of existing customer discharge (e.g., sometimes referred to in some segments as churn, attrition, or prepayment risk).

For the above purposes, the system can use both historical and current data to determine the discharge propensity, risk profile, present or future customer value, optimal price and/or product offering, and/or optimal treatment method to enable optimal acquisition and retention activities for providers of products and/or services (e.g., subscriptions, loans, credit lines, insurance policies, etc.). The historical data (e.g., credit bureau, real estate databases, behavioral, etc.) is obtained to seed models used by the system, and then current or new data from the same data classes can be obtained to power the self-adaptive aspects of the system in an ongoing manner. Such products and services can include or relate to, for example, mortgage loans and insurance products. The presently described system can also be configured to provide similar services for other industries or industry participants including title insurance providers, telecommunication providers, social media-based feeds or subscriptions, retail, mortgage default insurers, and the residential mortgage backed security (MBS) market. The present disclosure provides examples in the context of a mortgage lender and associate activities, for illustrative purposes only. The principles discussed herein equally apply to other industries and segments concerning products and/or services.

The system described herein can generate predictions to determine the propensity for a group of customers to discharge from their current provider. The system can further segment and personify customers based on risk profile, present or future value, optimal price and/or product offering, and/or optimal contact channel method to treat the customer. These variables can also be used to optimize profit when combined together.

The system is configured to increase and enhance customer acquisition and retention efficiency when targeting or retargeting identified consumer/customer segments, respectively. To make these predictions and recommendations, the system uses a stream of historical and current data, including for example, credit bureau, real estate, geographic, demographic, psychographic, economic, behavioral (i.e. data logged by a system, for example clickstream data), news, and social media data. In some cases, customers can be provided with an option, and be required to consent to the sharing of their personal data in order to receive outputs resulting from the above activities. It can be appreciated that various user consent mechanisms can be used, where appropriate. For example, if the user has decentralized control of their own data, that user can approve the use of that data by a third party. The user may also be given the option to opt-in and provide further personal data, which would provide them with a more personalized experience and/or more personalized product offerings. For example, if a user has multiple financial products from multiple financial institutions, and the system is unable to directly pull that data, the customer can be given the option of providing this additional information.

In one example scenario, in the event a homeowner is transitioning between selling their home and purchasing a new one, the system can make predictions based on a number of factors, including, for example, discharge propensity, risk profile, future value, price and/or product recommendation, and treatment recommendation.

Discharge Propensity:

In the above example, the sale and/or purchase of a home is often seen as a threat to the existing mortgage loan provider, and an opportunity for a provider seeking to target and ultimately acquire these types of customers during their transitionary period. In these circumstances, it is common for brokers and realtors involved in the process to act as influencers who sway customers away from the existing provider.

Risk Profile:

The system can be operated to determine when the risk profile of customers (or groups of customers aligned based on their personas) change over time. In the above example, the existing provider may choose to retarget the customer before or during their property switch, but alternatively, they may want to route the customer to a partner channel. For example, customers with a subprime mortgage often improve their financial situation over the years, and naturally discharge to acquire a prime mortgage from another provider. In contrast, customers with a prime mortgage may no longer fit the risk profile of their existing provider. In both cases, the system would have the ability to segment customers and facilitate an exchange between partner providers.

Future Value:

The system can be operated to determine the present or future value of the customer based on factors such as mortgage balance, home valuation, and other products which they have, or are expected to acquire in the future. For retention purposes, the system may predict the propensity of a group of customers with aligned personas to purchase insurance in the near term, and an equity line of credit and auto loan in the years to come. For acquisition purposes, the system may determine that a customer with an auto loan has a high propensity to purchase a mortgage in the near term, enabling seamless cross-selling opportunities for providers. In both cases, the system assesses the impact of a provider targeting or retargeting these customers (or consumers that wish to be customers) in relation to the overall customer portfolio.

Price and/or Product Recommendation:

The system can also be operated to determine a personalized price and/or product to offer the customer at the point of acquisition (origination) and renegotiation. In the case of a mortgage loan, the goal is to maximize Net Interest Margin, while reducing the risk of the customer selecting another provider. This threshold can be automatically learned by the system as it is exposed to new outcomes, as described in greater detail below.

Treatment Recommendation:

The system can also be operated to determine the most optimal channel for the provider to contact the customer using existing channels to that customer, or via automated digital channels controlled by the provider or system. The system can also be configured to select or advise the channel (e.g., branch, call center, marketing, digital) the customer is most likely to respond to favorably. The system can also be used to automate the messaging by not only selecting the appropriate channel, but also inserting that messaging and automating the delivery to offload further tasks from the provider. The goal is to provide a more transparent and guided experience to the customer, while enabling treatment channels with a more efficient mechanism of prioritizing and contacting customers. For example, in the property switch example, if it is determined that during the customer's amortization period, they use digital channels to buy and sell their home, the system would recommend a strategy in line with contacting the customer on the same channel. The same applies to internal sales teams, marketing channels, or external or partner channels such as realtors.

The system is operable to improve the computer-implemented functionality of the processes described herein in several ways. First, generating a prioritized list based on discharge (and other factors) would not be possible for a group of employees at the provider to achieve, particularly on a large customer portfolio, as there are too many factors to consider. As such, the system enables the providers the capability of performing a task which was not possible without the system being interfaced with the provider. Second, a prioritized list is created that evolves over time, which increases performance (e.g., retention rate (holding on to future revenue)). By interfacing with the system, a provider has the ability to decrease acquisition (origination) and marketing costs, increase retention rates, and in the case of some financial products, increase Net Interest Margin, and finally, reduce the human requirement to manage and contact customers. Instead, the system segments customers who do not need to be contacted, and prioritizes persuadable customers at risk of leaving, maximizing retention and profitability.

For example, if a lender (provider) with a limited sales force has 40,000 customers to contact and negotiate within a given month, the system can be used to streamline this process as a limited sales force may not be capable of contacting all of these customers. In this way, the system provides efficiencies in segmenting the customers to different channels so that the provider only has to use their most expensive resource (employee time) on those customers who are not likely to respond favorably to other channels. Moreover, the system enables the provider to optimize the offers to customers on all channels, so as to decrease the time spent negotiating with the customers while keeping an optimal Net Interest Margin. Combined, it can be appreciated that this reduces resource costs while increasing profitability.

It can be appreciated that when compared to existing methods, the presently described system is configured such that with each interaction, statistical attributes and data are collected and stored to enable the system to self-adapt to learn new recommendation strategies and approaches which maximize acquisition and retention related activities. The data can be captured via a feedback loop (described further below) from the channel used. For example, on digital channels, the data can include: “Did the customer click the offer or ignore it?; “How long did that customer stay on the offer page?”; “How did they interact with the offer page? Did they take a call to action (accept offer, decline offer, negotiate a different offer, etc.)?” ; “If contacted by an employee, was it through email or by phone?”; “What time did the interaction occur?”; “Which other products have they viewed?”; etc. The capturing of data can be done via an app, a widget on the website, or with more systematic feedback procedures from provider employees (e.g., via questionnaires, notes, system logs, etc.). The self-adaptive agent then considers this generated data within the context of what it has learned about the problem landscape thus far. This allows the agent to remain extremely robust to subtle changes in the environment (such as rising interest rates, new government regulations, etc.) for dynamic problem landscapes. Thus, predictions tend to remain accurate for a much longer period of time in comparison to a traditional “static” model, which tend to decay. The prevention of this accuracy decay is especially prevalent for the self-adaptive agent when the problem landscape exhibits a cyclical nature.

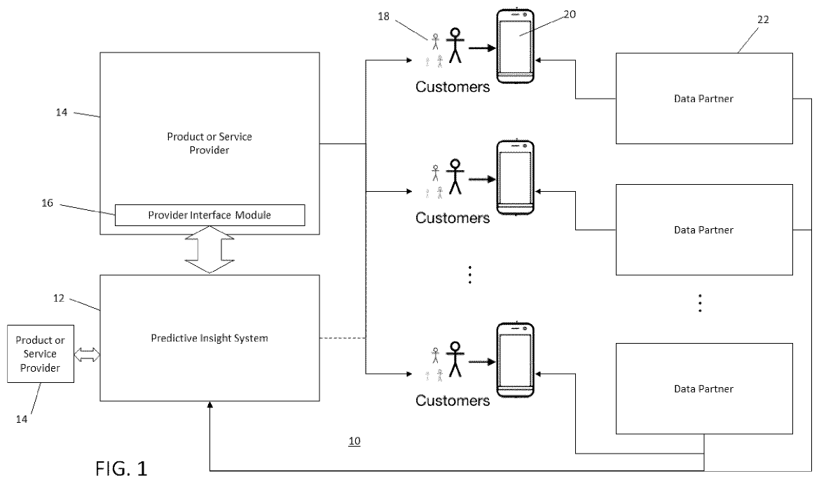

Turning now to the figures, FIG. 1 illustrates an example of a computing environment 10 in which a predictive insight system 12 is deployed. The predictive insight system 12 in this example is a centralized service that can be interfaced with and operable for multiple product or service providers 14 have a provider interface module 16. However, it can be appreciated that separate predictive insight systems 12 can be deployed within individual provider infrastructure, e.g., within the provider's enterprise network. That is, the system 12 can be a centralized service that is able to provide the solution to multiple providers (i.e. clients of the system 12). It can be appreciated that certain components can be deployed locally (e.g., the interface module 16 and optionally modules used for generating predictions), with other components located in the cloud (e.g., training modules and data repositories). In another example, the provider 14 may include a portion of the system's solution which houses customer data, which is passed to the system 12 via an application programming interface (API) or other interface.

In this example, the provider 14 and optionally the predictive insight system 12 is/are in at least some way interactive with the customers 18 being targeted, e.g., via various communication channels, existing relationships (with provider or system), public portals, etc. The customers 18 typically (but not always) have or have access to one or more computing and/or communication devices 20 (collectively referred to hereinafter as “customer devices 20”). Examples of such customer devices 20 include smart phones, tablet computers, laptop computers, desktop computers, wearable devices, in-vehicle infotainment or navigation systems, gaming devices, augmented reality or virtual reality devices, other entertainment devices, and so on.

Such customer devices 20 are naturally in most cases connected to at least one other network, system, service, etc., and thus come into contact with, share data, and are observed or interacted with by one or more data partners 22. For example, a data partner can include financial institution or government websites, social media services and accounts, retail websites or establishments, etc. The data partners 22 can therefore represent any entity that has at least some interaction with the customers 18 being targeted and are either associated with or can otherwise provide its data to the system 12, to be used as explained in greater detail below. The data partners 22 are therefore entities that have some form of direct or indirect relationship with the customer 18 and thus are able to provide the system 12 with data associated with that customer 18.

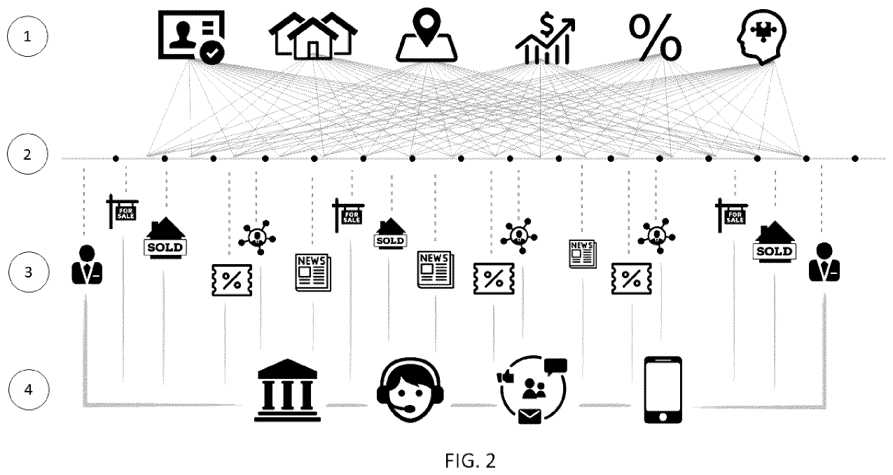

FIG. 2 provides a graphical illustration of the types of predictions that can be made by the system 12, in a mortgage lending example.

In stage 1, the system 12 aggregates, cleans, and transforms vast amounts (e.g., terabytes or more) of proprietary market data, such as credit, real estate, geospatial, economic, behavioral or other data logged by a system or service, etc., as well as the decision variables mentioned above. In this stage, the raw data gets transformed into a structured set of decision variables, which the system 12 carefully analyzes to make its prediction.

In stage 2, the system 12 monitors the relevant product or service across different relevant time scales. For example, in a mortgage application, the system monitors mortgages and examines amortization, term, time of year, life stage, etc.

In stage 3, the system examines the circumstances which may preempt discharge or churn of the product or service. In the mortgage application, circumstances which preempt mortgage discharge can be surfaced to lenders. The circumstances can include, for example, property sale, rate shopping, brokers, loan officers, news, etc.

In stage 4, the system 12 operates to determine optimal strategies that can be recommended to acquisition and/or retention channels. In this way, the provider 14 can be given insight into what strategies should be used and when to address potential discharge or acquisition events. In the mortgage example, this may include providing recommendations to branches, call centers, realtors, web channels, mobile channels, external partner channels, etc.

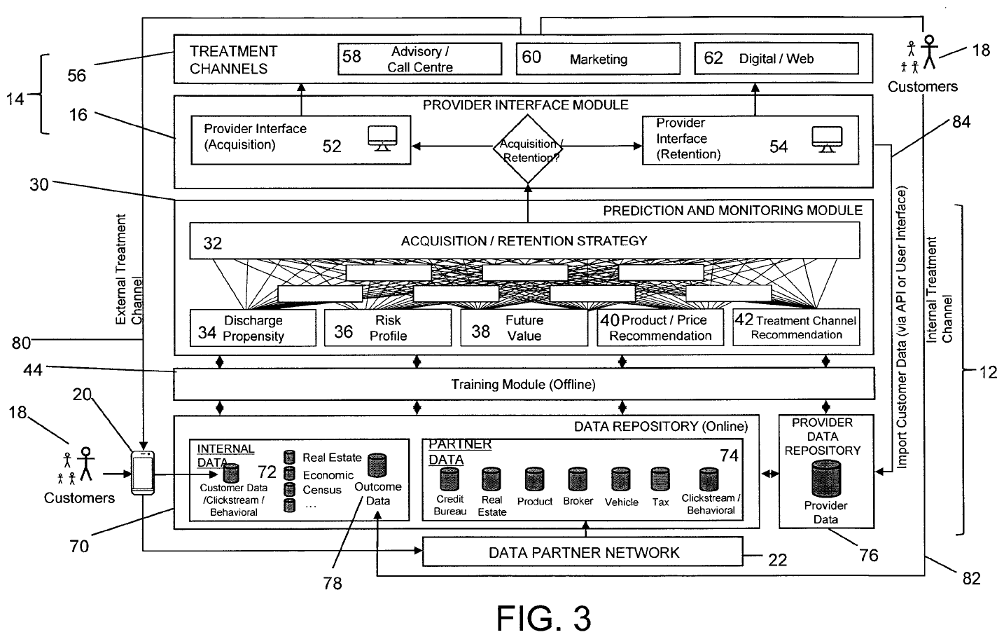

Additional details of the predictive insight system 12 and its integration/interface with the providers 14 is shown in FIG. 3. In one implementation, the system 12 as exemplified in FIG. 3 is hosted in a private cloud environment. As noted above, the system 12 can include core functionality in its own private cloud network (e.g., using a commercially available web service), with certain aspects necessary for day-to-day operations (e.g., the interface module 16 and components related to performing the predictions) could be housed by the provider 14.

The system 12 includes a prediction and monitoring module 30, which includes an acquisition/retention strategy module 32 for providing an output prediction to the provider 14. The prediction and monitoring module 30 also includes a discharge propensity module 34 configured to determine the propensity customer discharge, a risk profile module 36 configured to determine the risk profile of a customer 18, a future value module 38 to determine a future value of a customer 18, a product recommendation module 40 configured to generate product recommendations for the provider to suggest to a customer 18, and a treatment recommendation module 42 configured to generate recommendations for channels and other communication mechanisms to contact customers 18. These independent decision variables are often combined and then optimized as a whole, e.g., optimizing (by discharge propensity and customer value) results in maximum profit for the customer pool being considered by the model.

The system 12 also includes a training module 44, which is configured to handle all data pre-processing, model training, and model selection operations, as discussed in greater detail below. The training module 44 is in communication with both the prediction and monitoring module 30 and an online data repository 70 and a provider data repository 76. The provider data repository 76 can be populated by importing customer data to the system 12, via an application programming interface (API) or from the provider interface module 16 as illustrated in FIG. 3. The provider data repository 76 houses the provider (e.g., mortgage lender) data which is initially created by the system 12 when the customer is onboarded and updated with each new upload.

The online data repository 70 includes a partner data repository 74 and an internal data repository 72. The partner data repository 74 can be populated via interfaces with data partner network(s) 22 as shown in FIG. 3. In this example, the partner data repository stores a variety of data attributes from a wide variety of data sources. This can include, for example, credit bureau, real estate, geographic, demographic, psychographic, economic, behavioral or other customer data logged by a system, news, and social media data. Some data attributes may be specific to a given property, area, demographic, or persona type.

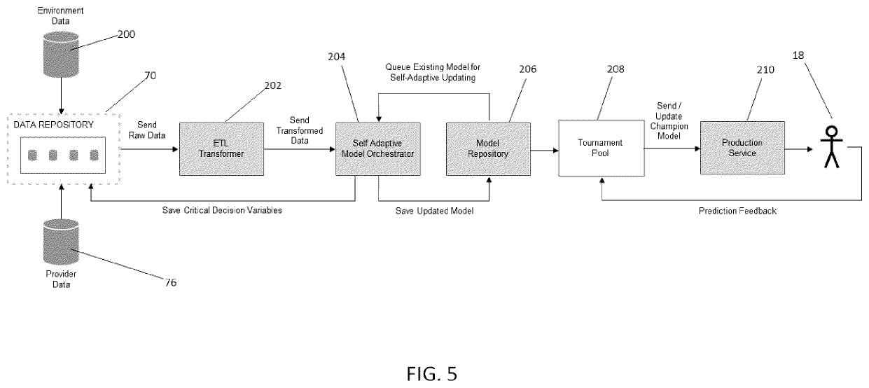

The internal data repository 72 shown in FIG. 3 stores public and propriety datasets collected or generated by the system 12. It can be appreciated that generated data can refer to outcome data and any decision variables related to the data sets in the internal data repository 72. Collected data refers to any of the raw data sources shown in FIG. 3. This includes, for example, real estate, economic, census, customer data logged by a system, and outcome data on historical predictions and recommendations. The internal data repository 72 also stores outcome data 78. The outcome data 78 corresponds to the statistical attributes and data, as described above. That is, the outcome data 78 corresponds to the feedback data that the self-adaptive agent of the system 12 requires to learn whether or not its predictions were correct, and how the system 12 can improve for future predictions. The outcome data 78 can also be used to determine which model of the tournament pool (see FIG. 5) is the best, thereby providing a small boost in prediction accuracy within the production service. It can be appreciated that the outcome data is preferably generated in real-time. As illustrated in FIG. 3, the customers 18 when interacting with their various customer devices 20 can lead to the generation of the data that is stored by the internal data repository 72.

As discussed above, the provider 14 includes a provider interface module 16, which interfaces with the system 12. In this configuration, the provider interface module 16 includes logic to process incoming prediction data from the prediction and monitoring module 30 to determine if the prediction is related to acquisition or retention. For acquisition-related data, the provider interface for acquisition 52 can be used to initiate treatment channels 56. For example, the channels 56 can include an advisory or call center 58, a marketing channel 60, and/or a digital/web channel 62. For retention-related data, the provider interface for retention 54 can be used to initiate one or more of the treatment channels 56.

FIG. 3 also illustrates certain feedback channels between the provider 14 and the system 12 or customer 18. For example, an external treatment channel 80 can communicate directly with the customer 18 via their corresponding device 20. Alternatively, internal treatment channels 82 (e.g., lender branches, call centers, etc.) can communicate directly with the customer 18. In both cases, a feedback channel is established between the treatment channels 56 and the outcome data 78 to capture the feedback data that the self-adaptive aspect of the system 12 requires to learn whether or not its predictions were correct, and how the system 12 can improve for future predictions.

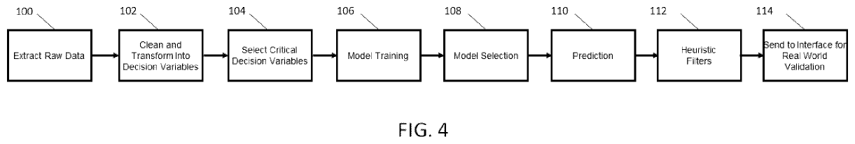

Turning now to FIG. 4, operations performed by the training module 44 are shown, suitable for an initial onboarding of a customer. Raw data is first extracted at 100 from all three data repositories 72, 74, 76. Raw data is cleaned and transformed at 102 into a set of decision variables suitable for model building. For example, this layer may remove duplicate attributes, impute missing data attributes, or generate new features based on domain knowledge engineered in the system. The system then selects the decision variables which are most optimal for model training at 104 based on statistical analysis of factors such as entropy and available computational resources used by the system 12.

A model training operation 106 includes building and optimizing multiple models for each prediction class using the data attributes supplied by the critical decision variables selected 104. It can be appreciated that many of compute jobs can be created in parallel to optimize the model. These prediction classes include but are not limited to discharge propensity 34, risk profile 36, future value 38, product recommendation 40, and treatment recommendation 42 (as illustrated in FIG. 3). For example, a product recommendation 40 for a mortgage lender may seek to maximize the Net Interest Margin on a mortgage product while staying below a threshold that would trigger the consumer to shop the open market. Each prediction class could use any combination of machine learning algorithms, including, for example, decision trees, clustering, neural networks, or genetic programming. Of the trained models, a small subset of the models with the best potential for acquisition retention value (or any desired metric) can be selected for promotion into production.

The trained models are then sent to a “tournament pool” (described below) for model selection 108.

When the prediction and monitoring module 30 generates an output at step 110 as shown in FIG. 4, one or more heuristic filters are applied at step 112. The heuristics filter checks every prediction made by the prediction and monitoring module 30 to ensure it doesn't violate any business rules. These heuristics are designed and validated on an ongoing basis, market by market. For example, in many markets there are debt to income ratio requirements that may change over time and would not be reflected in the historical data. This heuristic filter would be used in combination with the prediction and monitoring module 30 to ensure this requirement is met. All heuristic violations are logged as outcome data 78 and used for retraining so that the models learn changes in laws, regulations, compliance, or provider requirements. That is, business rules would supersede the prediction in what is delivered to the interface 114.

Referring now to FIG. 5, a more detailed implementation of what is shown in FIG. 4 is provided. The online data repository 70 can be used to store all data used by the models. This can include regular datasets (census, credit bureau, etc.), and “environment” datasets 200 for context variables. Environment datasets 200 contain information and data such as the current interest rate landscape, the current consumer sentiment around real estate on news websites, data logged by a system, etc. The data repository 70 can also extract data from the provider data 76 as shown in FIG. 5.

An Extract-Transform-Load (ETL) pipeline is used in this example to transform all raw data mentioned above into a format suitable for model training. The raw data is sent from the data repository 70 to an ETL transformer 202 for this purpose. The ETL transformer 202 sends the transformed data to a self-adaptive model orchestrator 204. The self-adaptive model orchestrator 204 receives the transformed data and initiates all self-adaptive training subroutines for each problem domain. In this phase, the “critical decision variables” are first selected, representing the decision variables that are most important to the model at that point in time. When these variables are selected, the dataset is trimmed to only these variables and a copy of this trimmed dataset is saved back to the data repository for future training. The self-adaptive orchestrator 204 then commences training new models on these variables as usual, saving the best model to a model repository 206.

At frequent intervals, the model orchestrator 204 can receive new “self-adaptive update” jobs via a job queue. Existing models from the repository are read into memory, and these models undergo another training process which involves training them to detect large-scale changes in the environment, allowing them to self-adapt to changes in customer persona, sentiment and financial environments for different problem landscapes. Techniques similar to stochastic gradient descent are also used to allow the model to learn from new customers.

The model repository 206 is responsible for vending the current set of N best models to a production service/backend, which can be included as part of the prediction and monitoring module 30. These N models collectively form a “tournament” pool (including a “champion” and “challengers”). It may be noted that in this context, a “model” can refer to a set of stacked predictors or ensembled predictors (e.g., random forest). When a prediction is made on a customer 18, all of the N models in the tournament pool 208 make a prediction, which is saved for future comparison. At first, the prediction that is sent back to the provider 14 is selected randomly from the models in the tournament pool 208. However, as feedback is slowly streamed back to the tournament pool 208, each model's predictive performance is revealed, effectively serving as a real world test of each model in the tournament pool 208. The model with the highest predictive performance after a set period of time is deemed the “champion” model, and its predictions are chosen to be sent to the production service 210 from that point onwards (as opposed to randomly selecting a prediction from the models, as was performed before the champion emerged). It may be noted that tournament pools 208 are frequently restarted, as most models are effectively replaced every time the model orchestrator queues up a self-adaptive training job.

The output of the acquisition/retention strategy module 32 can be used to generate various user interfaces, such as those described below.

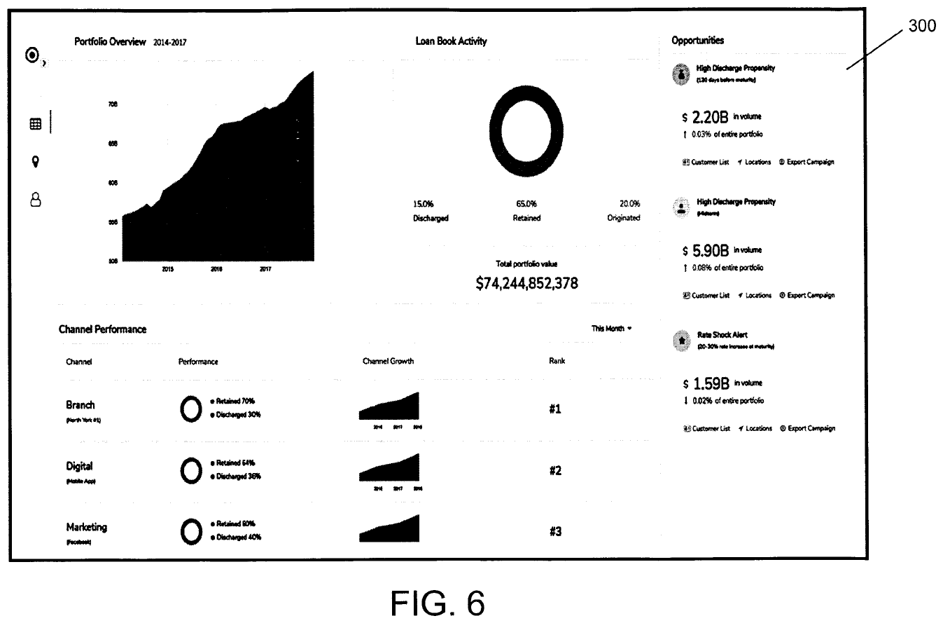

FIG. 6 shows an exemplary portfolio screen 300 which allows a provider 14 to see a high-level overview of their portfolio. For example, mortgage lenders are able to see how their portfolio has grown over time and which channels are performing the best. Some implementations may include a recommendation list of cohort based campaigns which were generated from the prediction engine. In FIG. 6 it can be seen that the portfolio screen 300 can include various visual elements and key numbers/indicators that may be of interest to the provider 14.

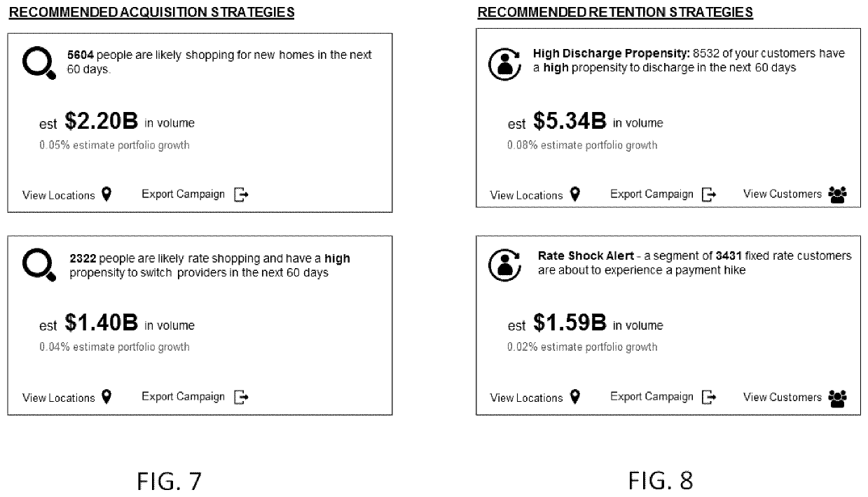

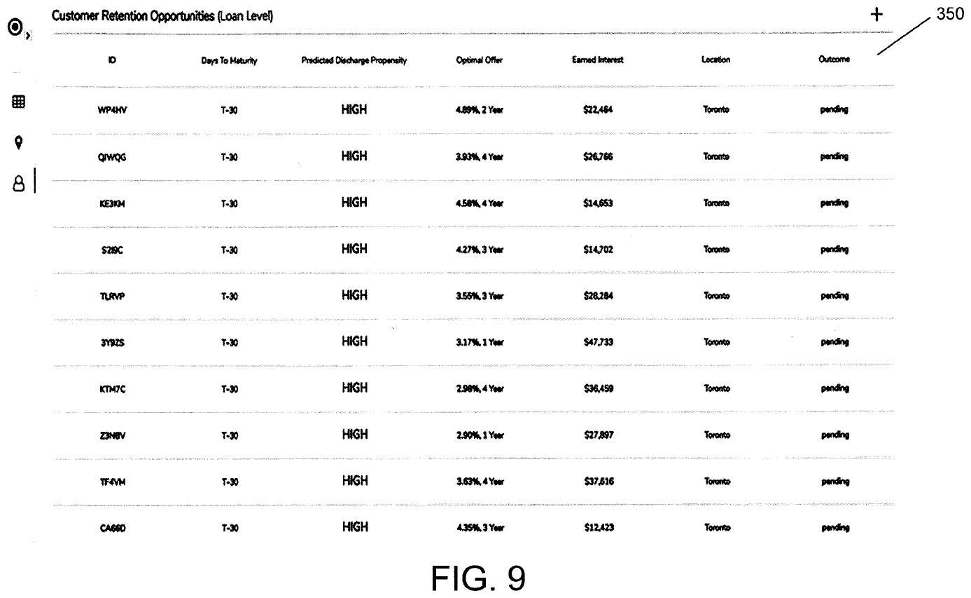

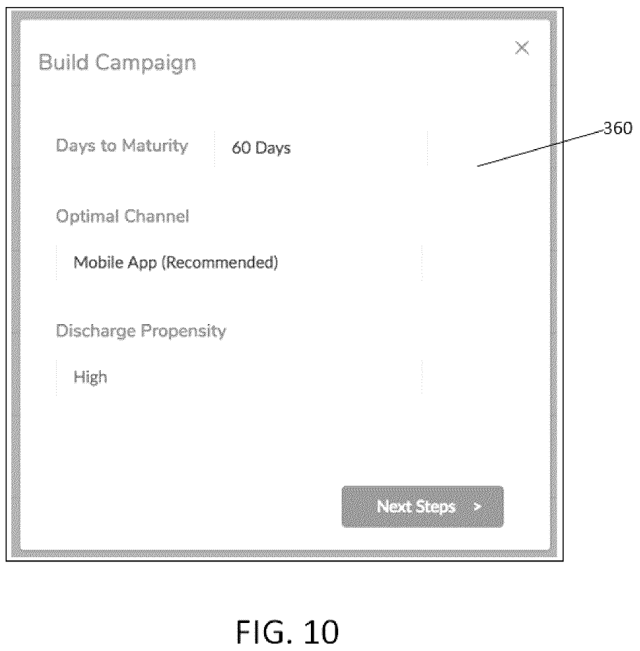

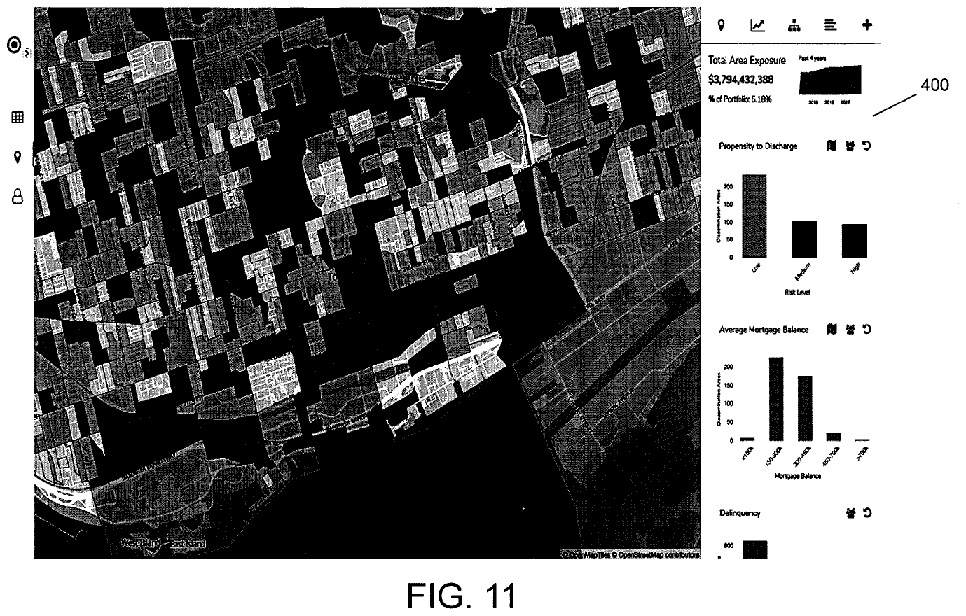

FIG. 7 shows an example of recommended acquisition strategies. In this example, the system 12 is indicating statistics on how many customers 18 are likely shopping for new homes, with a portfolio growth estimate. This allows the provider 14 to identify new home buyers as a potential acquisition target and provides options to view the associated location segment, which when clicked will go to a map (see FIG. 11) at the exact zoom level where all of these customers are located with relevant filters applied. The interface also includes an option to export a campaign, with an output tied to branch, call center, web, mobile, external partner channels, etc. (see also FIG. 10). FIG. 8 shows an example of a retention strategy recommendation related to a value associated with customers that have a high discharge propensity. This recommendation can provide a location option, an option to export a campaign, and an option to view the associated customer segment list (see FIG. 9—described below).

FIG. 9 shows an exemplary customer segment list screen 350 which allows users to see which customers have the highest risk of discharging, relative to all other customers in the portfolio. For example, mortgage lenders may want their sales people to focus their efforts in order to maximize retention. This screen can also provide optimized product recommendations and explanatory text as to why the customer is high-risk. The customer segment list screen 350 can be initiated by, for example, selecting a “View Customer” button on a zoom level of the map view shown in FIG. 8. This displays a list of customers in that view. It can be appreciated that various filters in the dashboard can be used to further segment the customer list. The “+” options allows one to initiate a campaign based on the filtered list determined by the user. The system 10 can also allow tracking of the progress of the campaign, including tracking of who has been contacted, what date, how they have responded, etc. The user has the ability to click on one customer row and contact that individual customer 18 directly. This may be used by an employee of the provider 14, versus a retention strategy team. For example, as shown in FIG. 10, an action 360 can be initiated by selecting a particular customer 18 in the screen 350. This action enables the provider 14 to build a campaign specifying a number of days until maturity and an optimal channel for that customer. This window can also be initiated by selecting “export campaign” in FIG. 7 or 8. The filters shown in FIG. 11 are only illustrative, and many other filters can be provided.

FIG. 11 shows an exemplary map view screen 400 which allows users to see their data and predictive insights aggregated by geography. For example, mortgage lenders can see which areas have high discharge rates and compare it to their portfolio exposure based on zoom level. In addition, the provider can select filters to further segment based on decision variables such as household income , household size, and credit score. This screen also allows the creation of sales campaigns for specific locations. When presented with an opportunity (or retention strategy), for example in FIG. 7, the user may select the location option and initiate the screen shown in FIG. 11 at the exact zoom level. If the user clicks on the ‘view customer’ option, then that user would initiate the screen 350 shown in FIG. 9 displaying the customers 18 in that specific cohort.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 12 or provider 14, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of generating insights related to customer acquisition and/or retention for a provider of a product or service, the method comprising:
obtaining historical and current data associated with customers;
generating at least one predictive insight associated with customer acquisition and/or customer retention using the data and at least one model;
for each interaction associated with contact with customers via a channel, collecting and storing outcome data comprising statistical attributes and data; and
self-adapting the at least one model using the stored statistical attributes and data to learn new recommendation strategies for customer acquisition and/or customer retention activities.

2. The method of claim 1, wherein the self-adapting comprises receiving updates at an orchestration module via a job queue; and retraining the at least one model to learn environmental changes in real-time.

3. The method of claim 1, further comprising utilizing a dynamic model pool to select a best predictor in real-time, based on changes in the environment.

4. The method of claim 1, wherein generating the at least one predictive insight comprises automatically personifying and segmenting customers based on a persuadability level in the event of that customer being contacted.

5. The method of claim 1, wherein the self-adapting comprises:
transforming raw data to generate transformed data;
initiating one or more self-adapting training subroutines for each problem domain, using the transformed data;
training the at least one model based on variables selected by a training subroutine; and
saving a best model to a model repository.

6. The method of claim 5, further comprising applying a champion model to select a model with a highest predictive performance.

7. The method of claim 1, further comprising using a training module to:
clean and transform the data into decision variables;
select critical decision variables;
perform model training;
perform model selection;
perform selection prediction; and
applying one or more heuristic filters.

8. The method of claim 7, wherein applying one or more heuristic filters to the generated prediction ensures the prediction does not violate a business rules.

9. The method of claim 1, further comprising providing the predictive insight to a provider via a provider interface to enable one or more treatment channels to be initiated.

10. The method of claim 1, further comprising importing customer data from the provider.

11. The method of claim 1, wherein the current data comprises data logged by a system based on customer activities.

12. The method of claim 11, wherein the historical and current data is used to personify the customer.

13. A non-transitory computer readable medium comprising computer executable instructions for generating insights related to customer acquisition and/or retention for a provider of a product or service, the method comprising:
obtaining historical and current data associated with customers;
generating at least one predictive insight associated with customer acquisition and/or customer retention using the data and at least one model;
for each interaction associated with contact with customers via a channel, collecting and storing outcome data comprising statistical attributes and data; and
self-adapting the at least one model using the stored statistical attributes and data to learn new recommendation strategies for customer acquisition and/or customer retention activities.

14. A system comprising a processor and memory, the memory storing computer executable instructions for generating insights related to customer acquisition and/or retention for a provider of a product or service, the method comprising:
obtaining historical and current data associated with customers;
generating at least one predictive insight associated with customer acquisition and/or customer retention using the data and at least one model;
for each interaction associated with contact with customers via a channel, collecting and storing outcome data comprising statistical attributes and data; and
self-adapting the at least one model using the stored statistical attributes and data to learn new recommendation strategies for customer acquisition and/or customer retention activities.

15. The system of claim 14, hosted in a private cloud environment.

16. The system of claim 14, wherein the self-adapting comprises receiving updates at an orchestration module via a job queue; and retraining the at least one model to learn environmental changes in real-time.

17. The system of claim 14, further comprising instructions for utilizing a dynamic model pool to select a best predictor in real-time, based on changes in the environment.

18. The system of claim 14, wherein generating the at least one predictive insight comprises automatically personifying and segmenting customers based on a persuadability level in the event of that customer being contacted.

19. The system of claim 14, wherein the self-adapting comprises:
transforming raw data to generate transformed data;
initiating one or more self-adapting training subroutines for each problem domain, using the transformed data;
training the at least one model based on variables selected by a training subroutine; and
saving a best model to a model repository.

20. The system of claim 14, further comprising using a training module to:
clean and transform the data into decision variables;
select critical decision variables;
perform model training;
perform model selection;
perform selection prediction; and
applying one or more heuristic filters.
